(19) United States
(12) Patent Application Publication
(10) Pub. No.: US 2010/0292367 A1
(43) Pub. Date: Nov. 18, 2010

(54) POLYESTER COMPOSITIONS FOR LONG-TERM OUTDOOR EXPOSURE

(75) Inventor: Thierry Arpin, Ambilly (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/778,220

(22) Filed: May 12, 2010

Related U.S. Application Data
(60) Provisional application No. 61/177,343, filed on May 12, 2009.

(51) Int. Cl. C08L 67/00

(52) U.S. Cl. 523/500

(57) ABSTRACT

The present invention relates to the field of ultraviolet light stabilized polyester compositions, particularly it relates to ultraviolet light stabilized polyester compositions for manufacturing articles having good mechanical properties and a good surface appearance upon long-term outdoor exposure and/or heat exposure.

### CROSS REFERENCE TO RELATED APPLICATIONS

This application claims the benefit of priority to U.S. Provisional Application No. 61/177,343, filed May 12, 2009.

### FIELD OF THE INVENTION

The present invention relates to the field of ultraviolet light stabilized polyester compositions, and more particularly it relates to ultraviolet light stabilized polyester compositions for manufacturing articles having good mechanical properties and a good surface appearance upon long-term outdoor exposure and/or heat exposure.

### BACKGROUND OF THE INVENTION

As a result of their good heat resistance, mechanical strength, electrical properties, good processability and other properties, thermoplastic polyesters are used in a broad range of applications including automotive applications; recreation and sport parts; home appliances, electrical/electronic parts; power equipment; and buildings or mechanical devices. However, many of these applications are used outdoors and require that articles made from polyesters be exposed to weathering conditions during normal use. If used in outdoor applications, polyester compositions or articles made thereof can be subject to rapid and severe degradation/deterioration because of weathering conditions such as for example high temperature, humidity, exposure to ultraviolet (UV) and other kind of radiations. Such kind of exposures to ultraviolet radiation and high temperature sources impair the properties of the article during normal use. Upon prolonged weathering conditions, articles made of polyesters can degrade, thus leading to a loss of physical properties like tensile strength and a diminished aesthetic appearance, for example discoloration and/or surface cracking.

In an attempt to improve the protection of a polyester composition against the deteriorating effect of light and high temperature, it has been the conventional practice to add light stabilizers to polyester composition.

US patent application 2003/0109629 discloses a polyester composition comprising an impact modifier, a hindered amine light stabiliser (HALS) and an UV absorber, especially a hydroxyphenyl-triazine UV absorber. However, the disclosed composition exhibits reduced colour change (expressed by deltaE) only for an indoor weathering exposure of 810 hours, i.e. about 34 days.

JP 2000-191918 discloses a composition comprising from 98.10 to 99.94 wt-% of a polyester, a compound comprising a triazine, a benzotriazole-based ultraviolet absorber and a hindered amine light stabiliser. However, molded articles based on the disclosed polyester compositions may suffer from an unacceptable deterioration of their mechanical properties upon a long-term weathering exposure and upon a long-term high temperature exposure.

Unfortunately, with the existing technologies and the commercially available light stabilizers for polymers, molded articles based on polyester compositions suffer from an unacceptable deterioration of their mechanical properties and aesthetic appearance upon a long-term weathering exposure and upon a long-term high temperature exposure. For this reason, the existing technologies are insufficient for highly demanding applications.

Consequently, there is a need for an efficient protection of polyester compositions and articles thereof against deterioration due to a weathering exposure, in particular light-induced degradation, and heat-induce thermo-oxidation.

### SUMMARY OF THE INVENTION

There is disclosed and claimed herein a polyester composition comprising a) at least one polyester resin; b) from at or about 0.3 to at or about 3 wt-% of at least three UV stabilizers; wherein one of the at least three UV stabilizers is b1), another one is b2) and another one is b3); and c) from at or about 1 to at or about 60 wt-% of one or more reinforcing agents, the weight percentage being based on the total weight of the polyester composition. Compositions according to the invention offer good stability against the deleterious effects of long-term weathering exposure (e.g. UV exposure) and good mechanical properties upon high temperature exposure.

### DETAILED DESCRIPTION OF THE INVENTION

As used throughout the specification, the phrases “about” and “at or about” are intended to mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The polyester composition of the present invention comprises at least one polyester resin. Preferably, the at least one polyester resin is present in an amount from at or about 10 to at or about 80 wt-%, more preferably, in an amount from at or about 20 to at or about 70 wt-%, and still more preferably in an amount from at or about 30 to at or about 60 wt-%; the weight percentages being based on the total weight of the polyester composition.

The at least one polyester resin is preferably selected from thermoplastic polyesters derived from one or more dicarboxylic acids and one or more diols, copolyester thermoplastic elastomers (TPC) and mixtures thereof. Thermoplastic polyesters are typically derived from one or more dicarboxylic acids (where herein the term “dicarboxylic acid” also refers to dicarboxylic acid derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other dicarboxylic acids that may be used to form the thermoplastic polyester include sebacic and adipic acids. Hydroxycarboxylic acids such as hydroxybenzoic acid may be used as comonomers. Examples of thermoplastic polyesters that can be included in the polyester composition according to the present invention may be selected from the group consisting of poly(ethylene terephthalate) (PET), poly(trimethylene terephthalate) (PTT), poly(1,4-butylene terephthalate) (PBT), poly(ethylene 2,6-naphthoate) (PEN), and poly(1,4-cyclohexyldimethylene terephthalate) (PCT), poly(1,4-butylene terephthalate) (PBT) and copolymers and blends of the same, and more preferably the polyester is poly(ethylene terephthalate) (PET), poly(trimethylene terephthalate) (PTT), poly(1,4-butylene terephthalate) (PBT), poly(1,4-cyclohexyldimethylene terephthalate) (PCT), and copolymers and blends of the same.

Copolyester thermoplastic elastomers (TPC) such as copolyetheresters or copolyesteresters are copolymers that have a multiplicity of recurring long-chain ester units and short-chain ester units joined head-to-tail through ester linkages, said long-chain ester units being represented by formula (A):

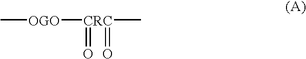

and said short-chain ester units being represented by formula (B):

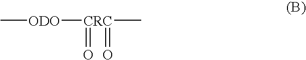

wherein
G is a divalent radical remaining after the removal of terminal hydroxyl groups from poly(alkylene oxide)glycols having preferably a number average molecular weight of between about 400 and about 6000; R is a divalent radical remaining after removal of carboxyl groups from a dicarboxylic acid having a molecular weight of less than about 300; and D is a divalent radical remaining after removal of hydroxyl groups from a diol having a molecular weight preferably less than about 250; and wherein said copolyetherester(s) preferably contain from about 15 to about 99 wt-% short-chain ester units and about 1 to about 85 wt-% long-chain ester units.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units. They are made by reacting a low molecular weight diol or a mixture of diols with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, and a more preferred diol is 1,4-butanediol.

Preferably, the polyester composition according to the present invention comprises one or more thermoplastic polyesters that are selected from poly(ethylene terephthalate) (PET), poly(trimethylene terephthalate) (PTT), poly(1,4-butylene terephthalate) (PBT), poly(ethylene 2,6-naphthoate) (PEN), poly(1,4-cyclohexyldimethylene terephthalate) (PCT), copolyester thermoplastic elastomers (TPC) and mixtures thereof. More preferably, the polyester composition according to the present invention comprises one or more thermoplastic polyesters that are selected from poly(ethylene terephthalate) (PET), poly(1,4-butylene terephthalate) (PBT) poly(1,4-cyclohexyldimethylene terephthalate) (PCT) and mixtures thereof.

The polyester composition according to the present invention comprises from at or about 0.3 to at or about 3 wt-% of at least three UV stabilizers, wherein one of the at least three UV stabilizers is b1), another one is b2) and another one is b3), the weight percentage being based on the total weight of the polyester composition.

Preferably, the at least three UV stabilizers are selected from the group consisting of b1) one or more benzotriazole derivatives, b2) one or more triazine derivatives and/or pyrimidine derivatives; and b3) one or more hindered amine derivatives (also known as hindered amine type light stabilizers (HALS)).

Preferably, the one or more benzotriazole derivatives b1) are present in an amount from at or about 0.01 to at or about 2.98 wt-%, the one or more triazine derivatives and/or pyrimidine derivatives b2) are present in an amount from at or about 0.01 to at or about 2.98 wt-%, and the one or more hindered amine derivatives b3) are present in an amount from 0.01 to at or about 2.98 wt-%, provided that the sum of b1)+b2)+b3) is between at or about 0.3 and at or about 3 wt-%, the weight percentage being based on the total weight of the polyester composition.

Preferably, one of the three UV stabilizers is one or more benzotriazole derivatives b1) having the following general formula (C) and combinations thereof:

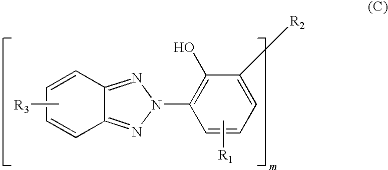

wherein R₁ is C₁-C₁₂ alkyl; C₁-C₅ alkoxy; C₁-C₅ alkoxycarbonyl; C₅-C₇ cycloalkyl; C₆-C₁₀ aryl; or aralkyl;
R₃ is hydrogen; C₁-C₅ alkyl; C₁-C₅ alkoxy; halogen, preferably chlorine; or hydroxy;
m is 1 or 2;
when m=1, R₂ is hydrogen; unsubstituted or phenyl-substituted C₁-C₁₂ alkyl; or C₆-C₁₀ aryl;
when m=2, R₂ is a direct bond between the phenyl groups; or —(CH₂)ₚ—;
and p is from 1 to 3.

By “combination thereof”, it is generally understood that when more than one stabilizers of the one or more benzotriazole derivatives b1), for example, are present in the polyester composition, the different stabilizers b1) can have different structures and can be independently selected from the general formula (C), all of these stabilizers having the general formula (C).

More preferably, the one or more benzotriazole derivatives b1) have the following general formula (D) and combinations thereof:

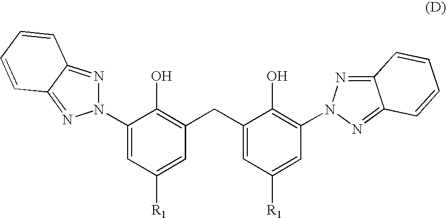

wherein R₁ is an C₁-C₁₂ alkyl.

Still more preferably, the one or more benzotriazole derivatives b1) have the following general formula (E):

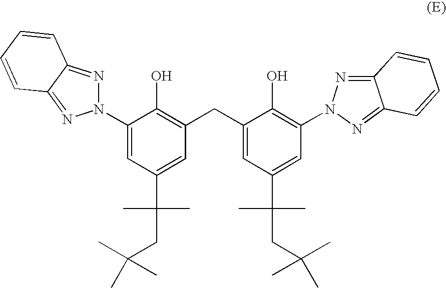

which benzotriazole derivative is 2,2′-methylenebis(6-(2H-benzotriazol-2-yl)-4-1,1,3,3-tetramethylbutyl)-phenol ((CAS number: 103597-45-1; also referred to 2,2′-methylenebis(6-(benzotriazol-2-yl)-4-tert-octylphenol)).

Preferably, the one or more benzotriazole derivatives b1) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1)+b2)+b3) is between 0.3 and 3 wt-%, the weight percentage being based on the total weight of the polyester composition.

Preferably, one of the three UV stabilizers is one or more triazine derivatives and/or pyrimidine derivatives b2) having the following general formula (F) and combinations thereof:

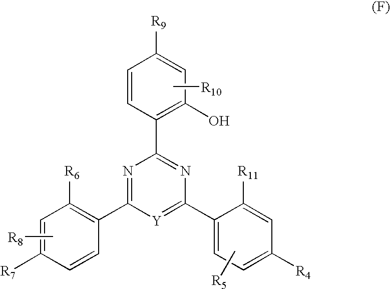

wherein Y is N (triazine derivative) or CH (pyrimidine derivative); and wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, or a combination thereof.

More preferably, the one or more triazine derivatives and/or pyrimidine derivatives b2) are triazine derivatives, i.e. Y is N (nitrogen), of the following formula (G) and combinations thereof:

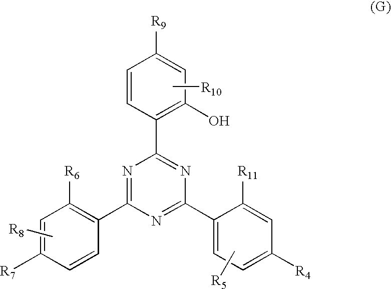

wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, or a combination thereof.

Still more preferably, the one or more triazine derivatives and/or pyrimidine derivatives b2) are compounds of the following general formula (H):

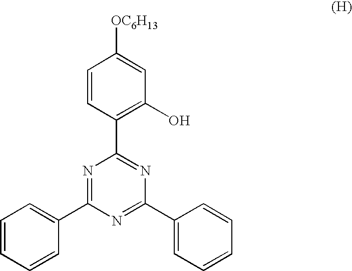

which triazine derivatives and/or pyrimidine derivatives is 2-(4,6-diphenyl-1,3,5-triazin-2-yl)-5-hexyloxy-phenol (CAS Nb 147315-50-2).

Preferably, the one or more triazine derivatives and/or pyrimidine derivatives b2) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1)+b2)+b3) is between 0.3 and 3 wt-%, the weight percentage being based on the total weight of the polyester composition.

Preferably, one of the three UV stabilizers is one or more benzotriazole derivatives b1) having the following general formulas (I) and combinations thereof:

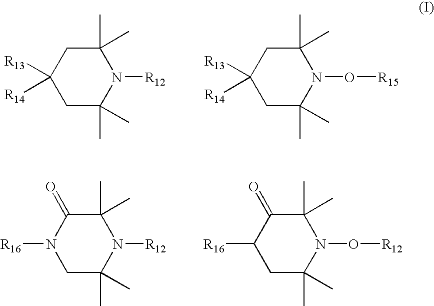

wherein R₁₂, R₁₃, R₁₄, R₁₅ and R₁₆ are each independently selected from the group consisting of hydrogen, ether groups, ester groups, amine groups, amide groups, alkyl groups, alkenyl groups, alkynyl groups, aralkyl groups, cycloalkyl groups, aryl groups or a combination thereof; in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. The one or more hindered amine derivatives may also form part of a polymer or oligomer.

More preferably, the one or more hindered amine derivatives b3) are compounds derived from a substituted piperidine compound, in particular any compound derived from an alkyl-substituted piperidyl, piperidinyl or piperazinone compound, and substituted alkoxypiperidinyl compounds. Still more preferably, the one or more hindered amine derivatives b3) are an oligomer of N-(2-hydroxyethyl)-2,2,6,6-tetramethyl-4-piperidinol and succinic acid, which oligomer has a molecular weight Mₙ of 3100-4000. (CAS number: 65447-77-0).

Preferably, the one or more hindered amine derivatives b3) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1) b2) b3) is between 0.3 and 3 wt-%, the weight percentage being based on the total weight of the polyester composition.

According to a preferred embodiment, the at least three UV stabilizers are:

b1) being 2,2′-methylenebis(6-(2H-benzotriazol-2-yl)-4-1,1,3,3-tetramethylbutyl)-phenol,
b2) being 2-(4,6-diphenyl-1,3,5-triazin-2-yl)-5-hexyloxy-phenol, and
b3) being an oligomer of N-(2-hydroxyethyl)-2,2,6,6-tetramethyl-4-piperidinol and succinic acid.

The polyester composition according to the present invention comprises one or more reinforcing agents. Preferably, the one or more reinforcing agents are selected from one or more glass reinforcing agents, one or more inert fillers and mixtures thereof.

Examples of glass reinforcing agents include without limitation non-circular cross-sectional fibrous glass fillers; glass fibers having a circular cross section and glass flakes. Non-circular cross-sectional fibrous glass fillers are fibrous glass fillers characterized by a non-circular cross section. The non-circular cross section have the shape of, for example, an oval, elliptic, cocoon or rectangular. Particularly preferred non-circular cross-sectional fibrous glass fillers are those having a non-circular cross-sectional aspect ratio of at or about 4. These kinds of non-circular cross-sectional fibrous glass filler are described and differentiated from conventional glass fillers by their cross-sectional aspect ratio and are differentiated from conventional glass flakes by their fibrous nature. The term “fibrous” in the context of the invention means composed of one or multiple filaments of glass. The “cross-sectional aspect ratio” is measured by cutting the fibrous glass filler perpendicularly to its longitudinal axis and measuring the ratio between the major axis of the cross section (i.e. its longest linear dimension) and the minor axis of the cross section (i.e. its shortest linear dimension perpendicular to the major axis). For comparison, glass fibers having a circular cross-section have a cross-sectional aspect ratio of about 1. Glass flakes fillers are differentiated from non-circular cross-sectional glass filler by their non-fibrous nature. Such non-circular cross-sectional fibrous glass fillers and poly(butylene)terephthalate compositions comprising such fillers are described in EP 0190011, EP 196194, EP 400935, EP 0246620, JP 03263457 and JP 03220260.

Examples of inert fillers include without limitation calcium carbonate, carbon fibers, talc, mica, wollastonite, calcinated clay, kaolin, magnesium sulfate, magnesium silicate, barium sulphate, titanium dioxide, sodium aluminum carbonate, barium ferrite and potassium titanate.

The one or more reinforcing agents are present in an amount from at or about 1 to at or about 60 wt-%, preferably from at or about 5 to at or about 50 wt-%, or more preferably from at or about 10 to at or about 50 wt-%, the weight percentages being based on the total weight of the polyester composition.

In an attempt to further improve heat aging characteristics, the polyester composition according to the present invention may further comprise one or more oxidative stabilizers (also referred as antioxidants or heat stabilizers). Preferably, the one or more oxidative stabilizers are selected from phenolic-based stabilizers, phosphorus-based stabilizers, hindered amine stabilizers, aromatic amine stabilizers, thioesters and mixtures thereof so as to hinder thermally induced oxidation of polyesters where high temperature applications are used. More preferably, the one or more oxidative stabilizers are selected from phenolic-based stabilizers, phosphorus-based stabilizers and mixtures thereof. Preferred examples of phenolic-based antioxidants are sterically hindered phenols. Preferred examples of phosphorus-based antioxidants are phosphite stabilizers, hypophosphite stabilizers and phosphonite stabilizers and more preferably diphosphite stabilizers. When present, the one or more oxidative stabilizers comprise from at or about 0.1 to at or about 3 wt-%, or preferably from at or about 0.1 to at or about 1 wt-%, or more preferably from at or about 0.1 to at or about 0.8 wt-%, the weight percentages being based on of the total weight of the polyester composition.

The polyester composition according to the present invention may further comprise one or more flame retardants (also referred to in the art as flameproofing agents). Flame retardants are used in thermoplastic compositions to suppress, reduce, delay or modify the propagation of a flame through the composition or an article based on the composition. The one or more flame retardants may be halogenated flame retardants inorganic flame retardants, phosphorous containing compounds and nitrogen containing compounds or a combination thereof.

Halogenated organic flame retardants include without limitation chlorine- and bromine-containing compounds. Examples of suitable chlorine-containing compounds include without limitation chlorinated hydrocarbons, chlorinated cycloaliphatic compounds, chlorinated alkyl phosphates, chlorinated phosphate esters, chlorinated polyphosphates, chlorinated organic phosphonates, chloroalkyl phosphates, polychlorinated biphenyls and chlorinated paraffins. Examples of suitable bromine-containing compounds include without limitation tetrabromobisphenol A, bis(tribromophenoxy)alkanes, polybromodiphenyl ethers, brominated phosphate esters tribromophenol, tetrabromodiphenyl sulfides, polypentabromo benzyl acrylate, brominated phenoxy resins, brominated polycarbonate polymeric additives based on tetrabromobisphenol A, brominated epoxy polymeric additives based on tetrabromobisphenol A and brominated polystyrenes.

Inorganic flame retardants include without limitation metal hydroxides, metal oxides, antimony compounds, molybdenum compounds and boron compounds. Examples of suitable metal hydroxides include without limitation magnesium hydroxide, aluminum hydroxide, aluminum trihydroxide and other metal hydroxides. Examples of suitable metal oxides include without limitation zinc and magnesium oxides. Examples of suitable antimony compounds include without limitation antimony trioxide, sodium antimonite and antimony pentoxide. Examples of suitable molybdenum compounds include without limitation molybdenum trioxide and ammonium octamolybdate (AOM). Examples of suitable boron compounds include without limitation include zinc borate, borax (sodium borate), ammonium borate and calcium borate.

Examples of suitable phosphorous containing compounds include without limitation red phosphorus; halogenated phosphates; triphenyl phosphates; oligomeric and polymeric phosphates; phosphonates phosphinates, disphosphinate and/or polymers thereof.

Examples of suitable nitrogen containing compounds include without limitation triazines or derivatives thereof, guanidines or derivatives thereof, cyanurates or derivatives thereof and isocyanurates or derivatives thereof.

When present, the one or more flame retardants comprise from at or about 5 to at or about 30 wt-%, or preferably from at or about 10 to at or about 25 wt-%, the weight percentages being based on of the total weight of the polyester composition.

Depending on the end-use application, the polyester composition may further comprise one or more hydrolysis stabilizers such as for example epoxy-containing compounds. Examples of suitable epoxy-containing compounds include without limitation an epoxy containing polyolefin, a glycidyl ether of polyphenols, a bisphenol epoxy resin and an epoxy novolac resin. Epoxy containing polyolefins are polyolefins, preferably polyethylene, that are functionalized with epoxy groups; by “functionalized”, it is meant that the groups are grafted and/or copolymerized with organic functionalities. Examples of epoxides used to functionalize polyofins are unsaturated epoxides comprising from four to eleven carbon atoms, such as glycidyl(meth)acrylate, allyl glycidyl ether, vinyl glycidyl ether and glycidyl itaconate, glycidyl(meth)acrylates (GMA) being particularly preferred. Ethylene/glycidyl(meth)acrylate copolymers may further contain copolymerized units of an alkyl (meth)acrylate having from one to six carbon atoms and an α-olefin having 1-8 carbon atoms. Representative alkyl(meth)acrylates include methyl(meth)acrylate, ethyl(meth)acrylate, propyl(meth)acrylate, butyl (meth)acrylate, isobutyl(meth)acrylate, hexyl(meth)acrylate, or combinations of two or more thereof. Of note are ethyl acrylate and butyl acrylate. Bisphenol epoxy resins are condensation products having epoxy functional groups and a bisphenol moiety. Examples include without limitation products obtained from the condensation of bisphenol A and epichlorohydrin and products obtained from the condensation of bisphenol F and epichlorohydrin. Epoxy novolac resins are condensation products of an aldehyde such as for example formaldehyde and an aromatic hydroxyl-containing compound such as for example phenol or cresol. When present, the one or more epoxy-containing compounds are present in an amount sufficient to provide from at or about 3 to at or about 300 milliequivalents of total epoxy function per kilogram of polyester, preferably from at or about 5 to at or about 300 milliequivalents of total epoxy function per kilogram of polyester.

The polyester composition according to the present invention may further comprise one or more tougheners. The toughener will typically be an elastomer having a relatively low melting point, generally lower than 200° C., preferably lower than 150° C. and that has attached to it functional groups that can react with the polyester (and optionally other polymers present). Since polyester resins usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric tougheners by grafting small molecules onto an already existing polymer or by copolymerizing a monomer containing the desired functional group when the polymeric tougheners molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughener wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl(meth)acrylate. In addition to ethylene and a functional (meth)acrylate monomer, other monomers may be copolymerized into such a polymer, such as vinyl acetate, unfunctionalized (meth)acrylate esters such as ethyl(meth)acrylate, n-butyl(meth)acrylate, and cyclohexyl(meth)acrylate. Preferred toughening agents include those listed in U.S. Pat. No. 4,753,980, which is hereby incorporated by reference. Especially preferred tougheners are copolymers of ethylene, ethyl acrylate or n-butyl acrylate, and glycidyl methacrylate, such as EBAGMA and ethylene/methyl acrylate copolymers. It is preferred that the polymeric toughener, if used, contain from at or about 0.5 to at or about 20 wt-% of repeat units derived from monomers containing functional groups, preferably from at or about 1.0 to at or about 10 wt-%, more preferably from at or about 7 to at or about 13 wt-% of repeat units derived from monomers containing functional groups. There may be more than one is type of repeat unit derived from functionalized monomer present in the polymeric toughener. It has been found that toughness of the composition is increased by increasing the amount of polymeric toughener and/or the amount of functional groups. However, these amounts should preferably not be increased to the point that the composition may crosslink, especially before the final part shape is attained.

The polymeric toughener may also be ionomers. Ionomers are thermoplastic resins that contain metal ions in addition to the organic backbone of the polymer. Ionomers are ionic copolymers formed from an olefin such as ethylene and α,β-unsaturated C₃-C₈ carboxylic acid, such as for example acrylic acid (AA), methacrylic acid (MAA) or maleic acid monoethylester (MAME), wherein at least some of the carboxylic acid moieties, preferably form 10 to 99.9%, in the copolymer are neutralized to form the corresponding carboxylate salts. Preferably, the one or more ionomers contain from about 5 to about 30 wt-% of acrylic acid, methacrylic acid and/or maleic acid monoethylester, the weight percentage being based on the total weight of the ionomer. Neutralizing agents are alkali metals like lithium, sodium or potassium or transition metals like manganese or zinc. Compounds suitable for neutralizing an ethylene acid copolymer include ionic compounds having basic anions and alkali metal cations (e.g. lithium or sodium or potassium ions), transition metal cations (e.g. zinc ion) or alkaline earth metal cations (e.g. magnesium or calcium ions) and mixtures or combinations of such cations. Ionic compounds that may be used for neutralizing the ethylene acid copolymers include alkali metal formates, acetates, nitrates, carbonates, hydrogen carbonates, oxides, hydroxides or alkoxides. Other useful ionic compounds include alkaline earth metal formates, acetates, nitrates, oxides, hydroxides or alkoxides of alkaline earth metals. Transition metal formates, acetates, nitrates, carbonates, hydrogen carbonates, oxides, hydroxides or alkoxides may also be used. Preferred neutralizing agents are sources of sodium ions, potassium ions, zinc ions, magnesium ions, lithium ions, transition metal ions, alkaline earth metal cations and combinations of two or more thereof, sodium ions being more preferred.

The polymeric toughener may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acryonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate. It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

When present, the tougheners preferably comprise from at or about 0.5 to at or about 15 wt-%, or more preferably from at or about 1 to at or about 10 wt-%, the weight percentages being based on the total weight of the polyester composition.

The polyester composition according to the present invention may further include modifiers and other ingredients, including, without limitation, lubricants, impact modifiers, flow enhancing additives, antistatic agents, coloring agents, nucleating agents, crystallization promoting agents and other processing aids known in the polymer compounding art.

Fillers, modifiers and other ingredients described above may be present in the polyester composition in amounts and in forms well known in the art, including in the form of so-called nano-materials where at least one of the dimensions of the particles is in the range of 1 to 1000 nm.

The polyester compositions according to the present invention are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

In another aspect, the present invention relates to a method for manufacturing an article comprising a step of shaping the polyester composition according to the present invention and to the shaped article made from the polyester composition of the invention. By “shaping” is meant any shaping technique, such as for example extrusion, injection molding, compression molding, blow molding, thermoforming, rotational molding and melt casting, injection molding and extrusion process being preferred.

The polyester compositions according to the present invention and articles made thereof are suited for a wide variety of uses. The polyester compositions according to the present invention and articles made thereof are particularly suited for applications where resistance against long-term weathering exposure is of concern, like for example for automotive parts, electrical/electronic parts, household appliances and furniture, structural components for machines (e.g. computers, disk drives), decorative or structural parts for building and construction application (e.g. outdoor signs, ornaments, parts of photovoltaic panels).

### EXAMPLES

The following materials were used for preparing the polyester composition according to the present invention:

Polyester: poly(ethylene terephthalate) supplied by Toray Saehan, Korea under the name PET chips A9203.
Glass fibers: characterized by a nominal fiber diameter of 10 μm and a standard cut length of 4.5 mm, supplied by Owens Corning Vetrotex, France under the name Vetrotex EC10 952.
Mica: delaminated pure phlogopite mica having an equivalent spherical diameter (D90 value) of 400 microns and a median size of 250 microns, supplied by Zemex Industrial Minerals, Atlanta, Ga., USA under the trademark Suzorite® 60-HK.
UV stabilizer b1: 2,2′-methylenebis(6-(2H-benzotriazol-2-yl)-4-1,1,3,3-tetramethylbutyl)-phenol (CAS Nb 103597-45-1) supplied by Ciba Specialty Chemicals, Tarrytown, N.Y., USA under the trademark Tinuvin® 360.
UV stabilizer b2: 2-(4,6-diphenyl-1,3,5-triazin-2-yl)-5-hexyloxy-phenol (CAS Nb 147315-50-2) supplied by Ciba Specialty Chemicals, Tarrytown, N.Y., USA under the trademark Tinuvin® 1577.
UV stabilizer b3: oligomer of N-(2-hydroxyethyl)-2,2,6,6-tetramethyl-4-piperidinol and succinic acid having a molecular weight Mₙ of 3100-4000 (CAS number: 65447-77-0), supplied by Ciba Specialty Chemicals, Tarrytown, N.Y., USA under the trademark Tinuvin® 622.
Diphosphite based antioxidant: supplied by G.E. Specialty Chemicals, Parkersburg, W. Va., USA under the trademark Ultranox® 626.
Phenolic based antioxidant: supplied by Ciba Specialty Chemicals, Tarrytown, N.Y., USA under the trademark Irganox® 1010.
Plasticizer: polyethylene glycol 400 di-2-ethylhexanoate supplied by C.P. Hall Company, Chicago, Ill., USA under the trademark Plasthall® 809.
Ionomer: a copolymer comprising ethylene and 15 wt-% MAA (methacrylic acid), wherein 59 wt-% of the available carboxylic acid moieties are neutralized with sodium cations, supplied by E. I. du Pont de Nemours and Company, Wilmington, Del., USA under the trademark Surlyn®.
Lubricant: oxidized polyethylene wax supplied by Degussa GmbH, Düsseldorf, Germany under the trademark Vestowax® AO1535.
Epoxy resin: produced from bisphenol A and epichlorohydrin and having an epoxy equivalent weight on solids of 2273-3846 g/eq, supplied by Hexion Speciality Chemicals, Columbus, Ohio, USA under the trademark Epikote™ 1009.
Ethylene epoxide copolymer: an ethylene butyl-acrylate glycidyl methacrylate copolymer (28 wt-% BA, 5.2 wt-% GMA) supplied by E. I. du Pont de Nemours and Company, Wilmington, Del., USA under the trademark Elvaloy®.
Black carbon masterbatch: black color masterbatch based on polyethylene supplied by Cabot Corp., Boston, Mass. under the name Cabot PE-3324.

TABLE 1

| | E1 |
|---|---|
| Polyester | 51.00 |
| glass fibers | 15.00 |
| Mica | 20.00 |
| UV stabilizer b1 | 0.20 |
| UV stabilizer b2 | 0.40 |
| UV stabilizer b3 | 0.20 |
| diphosphite based antioxidant | 0.20 |
| phenolic based antioxidant | 0.20 |
| Plasticizer | 2.90 |
| Ionomer | 3.45 |
| Lubricant | 0.90 |
| epoxy resin | 0.60 |
| ethylene epoxide copolymer | 3.27 |
| carbon black | 1.68 |

Ingredient quantities are given in wt-% on the basis of the total weight of the polyester composition.

The composition of the Example (E1) was prepared by melt blending the ingredients shown in Table 1 in a 40 mm twin screw kneader operating at about 260° C. using a screw speed of about 300 rpm, a melt temperature displayed of about 267° C. and a melt temperature measured by hand of about 281° C. Upon exiting the extruder, the compositions were cooled and pelletized.

What is claimed is:

1. A polyester composition comprising:
a) at least one polyester resin;
b) from at or about 0.3 to at or about 3 wt-% of at least three UV stabilizers; wherein one of the at least three UV stabilizers is b1), another one is b2) and another one is b3); and
c) from at or about 1 to at or about 60 wt-% of one or more reinforcing agents,
the weight percentage being based on the total weight of the polyester composition.

2. The polyester composition according to claim 1, wherein the one or more thermoplastic polyesters are selected from poly(ethylene terephthalate) (PET), poly(trimethylene terephthalate) (PTT), poly(1,4-butylene terephthalate) (PBT), poly(ethylene 2,6-naphthoate) (PEN), and poly(1,4-cyclohexyldimethylene terephthalate) (PCT), copolyester thermoplastic elastomers (TPC) and mixtures thereof.

3. The polyester composition according to any preceding claim, wherein the at least three UV stabilizers are selected from the group consisting of b1) one or more benzotriazole derivatives; b2) one or more triazine derivatives and/or pyrimidine derivatives; and b3) one or more hindered amine derivatives.

4. The polyester composition according to any preceding claim, wherein b1) is one or more benzotriazole derivatives being present in an amount from at or about 0.01 to at or about 2.98 wt-%, b2) is one or more triazine derivatives and/or pyrimidine derivatives being present in an amount from at or about 0.01 to at or about 2.98 wt-%, and b3) is one or more hindered amine derivatives being present in an amount from 0.01 to at or about 2.98 wt-%,
provided that the sum of b1)+b2)+b3) is between at or about 0.3 and at or about 3 wt-%,
the weight percentage being based on the total weight of the polyester composition.

5. The polyester composition according to any preceding claim, wherein b1) is one or more benzotriazole derivatives having the following formula (C) and combinations thereof: 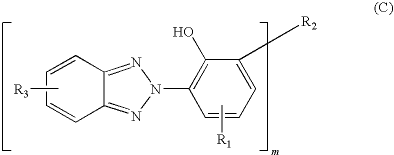
wherein R₁ is C₁-C₁₂ alkyl; C₁-C₅ alkoxy; C₁-C₅ alkoxycarbonyl; C₅-C₇ cycloalkyl; C₆-C₁₀ aryl; or aralkyl;
R₃ is hydrogen; C₁-C₅ alkyl; C₁-C₅ alkoxy; halogen;
m is 1 or 2;
when m=1, R₂ is hydrogen; unsubstituted or phenyl-substituted C₁-C₁₂ alkyl; or C₆-C₁₀ aryl;
when m=2, R₂ is a direct bond between the phenyl groups; or —(CH₂)ₚ—; and p is from 1 to 3.

6. The polyester composition according to claim 5, wherein b1) is 2,2′-methylenebis(6-(2H-benzotriazol-2-yl)-4-1,1,3,3-tetramethylbutyl)-phenol or has the following formula (E):

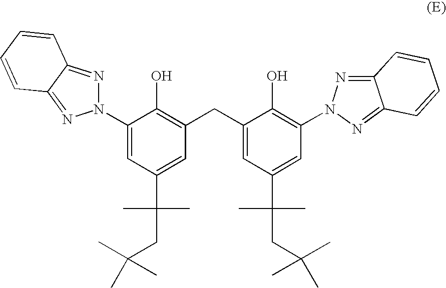

7. The polyester composition according to any preceding claim, wherein b2) is one or more triazine derivatives and/or pyrimidine derivatives having the following formula (F) and combinations thereof: 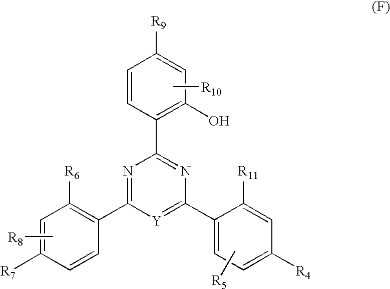
wherein Y is N (triazine derivative) or CH (pyrimidine derivative); and wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, or a combination thereof.

8. The polyester composition according to claim 7, wherein b2) is 2-(4,6-diphenyl-1,3,5-triazin-2-yl)-5-hexyloxy-phenol or has the following formula (H):

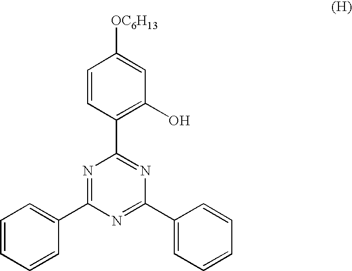

9. The polyester composition according to any preceding claim, wherein b3) is one or more hindered amine derivatives having the following formulas (I) and combinations thereof: 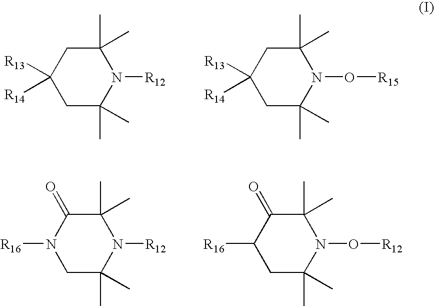
wherein R₁₂, R₁₃, R₁₄, R₁₅ and R₁₆ are each independently selected from the group consisting of hydrogen, ether groups, ester groups, amine groups, amide groups, alkyl groups, alkenyl groups, alkynyl groups, aralkyl groups, cycloalkyl groups, aryl groups or a combination thereof.

10. The polyester composition according to claim 9, wherein b3) is an oligomer of N-(2-hydroxyethyl)-2,2,6,6-tetramethyl-4-piperidinol and succinic acid.

11. The polyester composition according to anyone of claims 1 to 4, wherein:
b1) is 2,2′-methylenebis(6-(2H-benzotriazol-2-yl)-4-1,1,3,3-tetramethylbutyl)-phenol or has the following formula (E): 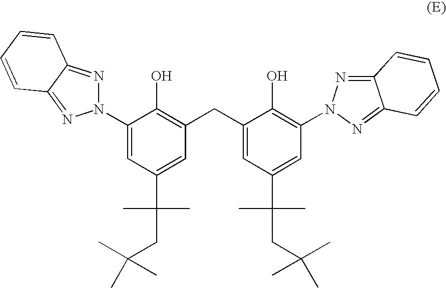
b2) is 2-(4,6-diphenyl-1,3,5-triazin-2-yl)-5-hexyloxy-phenol or has the following formula (H): 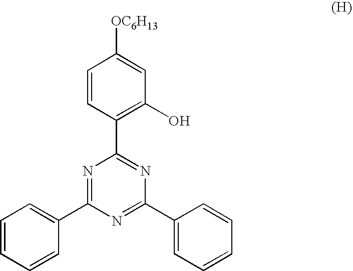
and b3) is an oligomer of N-(2-hydroxyethyl)-2,2,6,6-tetramethyl-4-piperidinol and succinic acid.

12. The polyester composition according to any preceding claim, wherein the one or more reinforcing agents are one or more glass reinforcing agents and/or one or more inert fillers.

13. The polyester composition according to any preceding claim further comprising one or more antioxidants.

14. The polyester composition according to claim 13, wherein the one or more antioxidants are present in an amount from at or about 0.1 to at or about 5 wt-%, the weight percentage being based on the total weight of the polyester composition.

15. The polyester composition according to claim 13 or 14, wherein the one or more antioxidants are selected from phenolic based antioxidant and diphosphite based antioxidants.

16. The polyester composition to any preceding claim further comprising one or more flame retardants.

17. The polyester composition according to claim 16, wherein the one or more flame retardants are present in an amount from at or about 5 to 30 wt-%, the weight percentage being based on the total weight of the polyester composition.

18. The polyester composition to any preceding claim further comprising one or more hydrolysis stabilizers.

19. The polyester composition according to claim 18, wherein the one or more hydrolysis stabilizers are epoxy-containing compounds in an amount sufficient to provide 3 to 300 milliequivalents of epoxy per kilogram of polyester.

20. An article made of the polyester composition recited in anyone of claims 1 to 19.
